(19) United States
(12) Patent Application Publication
(10) Pub. No.: US 2010/0314519 A1
(43) Pub. Date: Dec. 16, 2010

(54) Universal Support

(76) Inventors: James A. Watt, Carmel, IN (US); Kevin Watt, Greenwood, IN (US)

Correspondence Address: James A. Watt, 889 Cedarwood Place, Carmel, IN, 46032, US

(21) Appl. No.: 12/795,639

(22) Filed: Jun. 7, 2010

Related U.S. Application Data
(60) Provisional application No. 61/217,890, filed on Jun. 5, 2009.

(51) Int. Cl. F16M 13/00

(52) U.S. Cl. 248/274.1

(57) ABSTRACT

An improved and versatile mounting device, as shown, optionally includes a loop for receiving an adjustable band for supporting a utility, a recess for receiving a rod, and the loop optionally has a hole for receiving a fastener. The band adjusts to accommodate the size of the item being supported or the size of the structure to which the device is mounted.

### CROSS REFERENCE TO RELATED APPLICATIONS

This application claims the benefit of provisional application Ser. No. 61/217,890 filed Jun. 5, 2009 by the present inventors.

### FIELD OF THE INVENTION

This application generally relates to supporting or mounting devices.

### BACKGROUND

The construction of facilities, buildings, ships, and aircraft is cumbersome, difficult, and expensive because the support mounts must be coordinated with a particular size of apparatus. During installation the installer must have a supply of appropriately sized supports correlating to the utility being supported. If the installer mistakenly takes the wrong sized support, the installer must stop working, find the correct sized support, and return to the current work site. This can take a significant amount of time, particularly when the installer is working on a forty foot ladder. And considering that the installer is paid by the hour, it can also be expensive. Suppose, the on-site supply of the required support is exhausted and must be reordered, the project can be delayed for days or weeks while waiting for the part to arrive. Add in the potential of reordering the wrong size, wrong material, or wrong device and the project can be delayed even longer.

The reordering of the various sized supports and styles is cumbersome. To avoid running out of supports on the site, excessive numbers of the various supports are maintained in inventory. And considering that there are over 150 different support parts (variations of size and material choices), the number of extra parts can be significant and can take up significant space on the construction site or be left outside where these parts are subjected to the elements like rain. As a result, these parts can become unusable because of rust or subparts, such as screws or nuts, are lost.

### SUMMARY

In accordance with the invention, the support or mount is versatile. A connector incorporates adjustable straps, rods, or other fasteners for supporting or mounting utilities in a structure. In one embodiment, a connector has an adjustable strap and is used to support a variety of utility sizes eliminating the problems associated with having to use a particular support, material, or design with a particular sized utility.

### BRIEF DESCRIPTION OF THE SEVERAL VIEWS OF THE DRAWING

FIG. 1 shows a support according to one embodiment.

FIG. 2 shows a top perspective view of the connector shown in FIG. 1.

FIG. 3 shows a bottom perspective view of the connector shown in FIG. 1.

FIG. 4 shows a top plan view of the connector shown in FIG. 1.

FIG. 5 shows a side plan view of the connector shown in FIG. 1.

FIG. 6 shows a bottom plan view of the connector shown in FIG. 1

FIG. 7 shows the support of FIG. 1 secured to a mounting rod.

FIG. 8A shows a perspective view of the support shown in FIG. 1 with a fastener for mounting.

FIG. 8B shows a plan view of the support with fastener shown in FIG. 8A.

FIG. 8C shows a cross-section of the support with fastener shown in FIG. 8B.

FIG. 9 shows another embodiment of a support.

FIG. 10 shows a top perspective view of the connector shown in FIG. 9.

FIG. 11 shows a bottom perspective view of the connector shown in FIG. 9.

FIG. 12 shows a top plan view of the connector shown in FIG. 9.

FIG. 13 shows a side plan view of the connector shown in FIG. 9.

FIG. 14 shows a bottom view of the connector shown in FIG. 9.

FIG. 15 shows an application of the support shown in FIG. 9.

FIG. 16 shows the support of FIG. 20 attached to a mounting rod.

FIG. 17 shows an application of a support to a utility.

### DETAILED DESCRIPTION

Utility supports, such as pipe hangers, have to match the size of the utility, such as a pipe, that is being hung. For example, a 0.5 inch outside diameter pipe requires a 0.5 inch pipe hanger; a 1 inch outside diameter pipe, requires a 1 inch pipe hanger. This relationship exists for all sizes of pipe or conduit. Additionally, depending upon the function of the pipe, the pipe and hangers are made of specific materials and the material of the hanger must also correlate and be appropriate for the material of the pipe. When this piping is installed, the appropriate hanger material must also be used. This coordinating of pipes and hangers is susceptible to problems including running out of parts which results in delays. To avoid this situation, other problems are encountered, such as maintaining and stocking an excessive inventory of parts. The parts must be stored and are susceptible to rust or breaking.

To avoid such problems, a versatile connector for attaching an adjustable strap to a mounting rod or structure allows a single hanger to be used for supporting multiple sizes of pipe. It is also contemplated that the connector can attach to the structure via the strap. Alternatively, the connector can be used to attach a mounting rod to a structure, such as a wall, concrete, or steel.

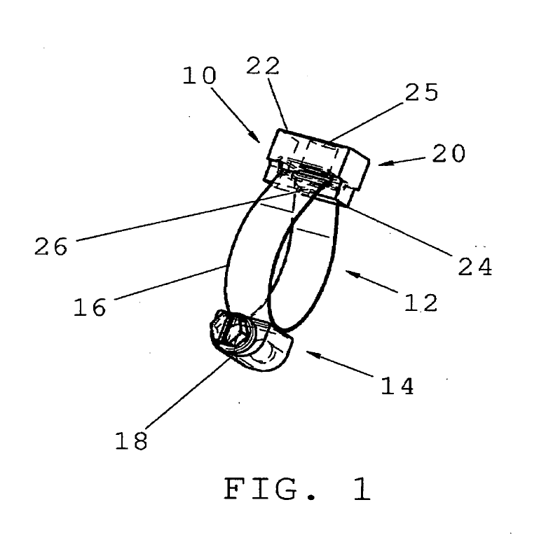

One embodiment of a support is illustrated in FIG. 1. As shown, the support 10 has a support band 12 and a connector 20. The support band 12 encloses an item or utility to be supported, including but not limited to piping, conduit, tubing, thin wall conduit, heavy wall conduit, hose, cable, duct, fiber optics, or any other object that can be held or clamped. For simplicity the specification uses the terms “utility” or “pipe” to refer to an item designed for practical use that is enclosed by the support band, but no limitation is intended by using these terms. Nor is the use intended to be limited to piping, conduit, tubing, thin wall conduit, heavy wall conduit, hose, cable, duct, or fiber optics. “Utility” also includes light switches and junction boxes. Because of the support's size, adjustability, strength, and weight, additional uses are likely and are only limited by the user's imagination.

The support band 12 can be made out of stainless steel, galvanized steel, copper, plastic, carbon fiber, or other materials depending upon the application. The support band 12 as illustrated is a worm gear clamp 14. It is contemplated that the support band 12 include other items such as zip ties (see FIGS. 30 and 31). The clamp 14 has a strap 16 and an operator 18 for adjusting the strap 16. Rotation of the operator 18 causes the strap 16 to move making the diameter (and circumference) of the strap 16 smaller or larger while the strap 16 is still fastened. Thus, strap 16 can be adjusted while strap 16 is supporting a utility. To help with operating operator 18, operator 18 can include a head that can accommodate a power tool, screw driver, or other operator for turning operator 18.

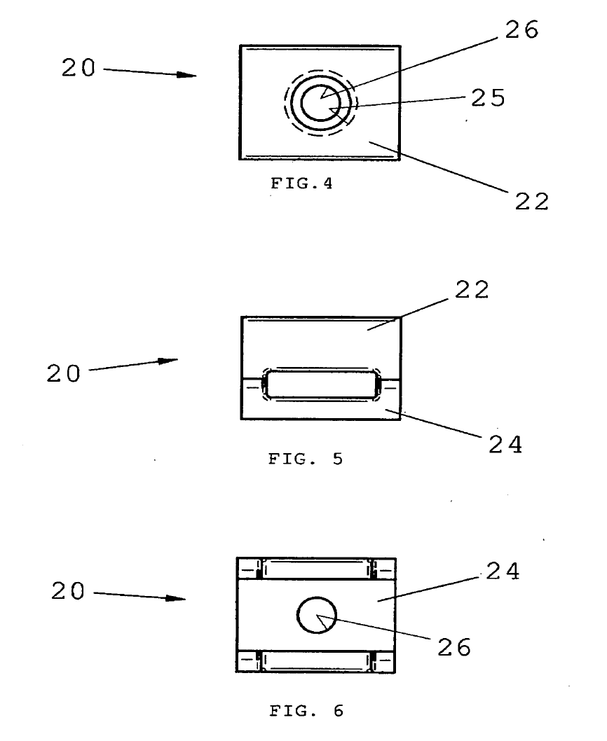

The connector 20 is shown in FIGS. 1, 2, 3, 4, 5, and 6 and has a receiver 22 and a loop 24. The receiver 22 has a recess 25 for receiving a mounting rod 44. In one embodiment recess 25 extends through receiver 22. It is also contemplated that the recess includes threads for receiving a threaded mounting rod. Alternatively, the rod is attached by friction fit to the recess 25 of receiver 22. It is further contemplated that the mounting rod 44 be attached to the receiver 22 using an adhesive.

The loop 24 extends from receiver 22 to form a gap for receiving band 12. Loop 24 is attached to receiver 20 by welding, adhesive, friction fit. Alternatively, loop 24 and receiver 20 are formed as a unitary body through known processes such as casting, forging, or powdered metal. In one embodiment loop 24 includes a hole 26 for receiving a fastener 48 for attaching connector 20 to a surface. It is also contemplated that connector 20 be secured to a surface using an adhesive.

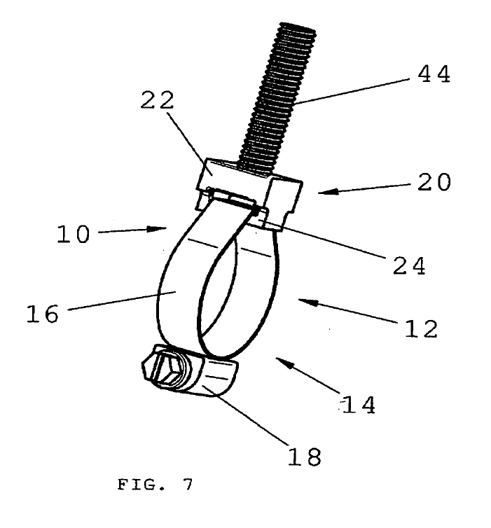

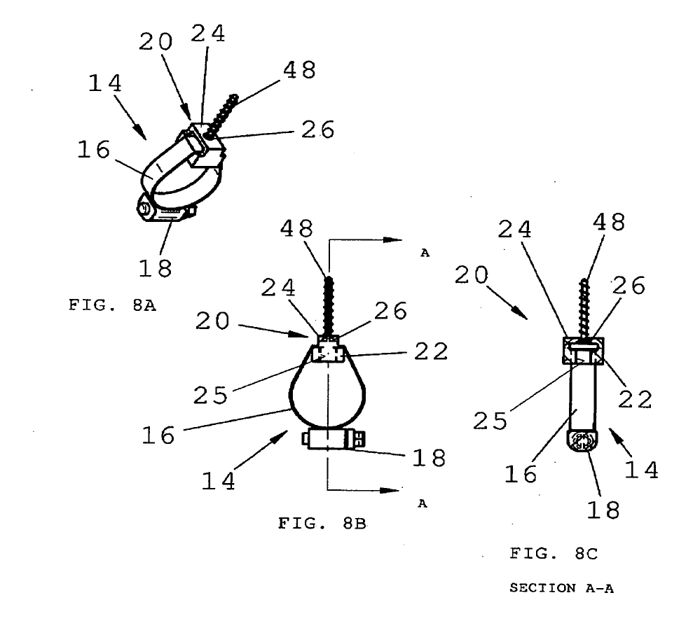

The operation or installation of the support 10 is discussed below. The connector 20 is attached is attached to a mounting rod 44, such as an all-thread rod, using the receiver 22 (see FIG. 7). The support band 12 is passed through the loop 24 of the connector such that the receiver 22 faces away from the band 12. The support band 12 is shown as a worm gear clamp 14 but could include other bands. The strap 16 is wrapped around an item or utility 40 (see FIG. 17) to be enclosed and the end of the strap 16 is inserted into the operator 18 which is then rotated to secure the end of the strap 16 into the operator 18. It is also contemplated that the support 10 be mounted with strap 16 fastened. The circumference of the band 12 is left larger than that of the utility to be supported. The utility is then inserted through the band 12 and the operator 18 is rotated to tighten the band 12 around the utility.

The installation of insulation around a utility is common and is easily installed using the support described above. The operator 18 is rotated to expand the strap 16. Insulation can be is inserted around the utility 40 and through strap 16. Then operator 18 is rotated to tighten the strap 16 around the utility 40 and insulation. Thus, the insulation 42 can be installed without having to undo and remove the original support and replacing it with a larger support to accommodate the insulation.

The support described above provides flexibility for other applications. For example, band 12 can be used to attach a support 10 to a structure. Band 12 wraps around the structure. Connector 24 is added to band 12. A second band 12 is attached to connector 24 through the gap between receiver 22 and loop 24.

In another embodiment, more than one connector 20 is attached to the strap 16. By using multiple connectors 20, mounting rods 44 can be used between items for spacing or additional support and for example, can be used in a plumbing chase. Alternatively, the support 10 can have connector 20 with more than one strap 16 through the loop 24 of the connector 20 for attaching utilities to one another or attaching utilities to columns.

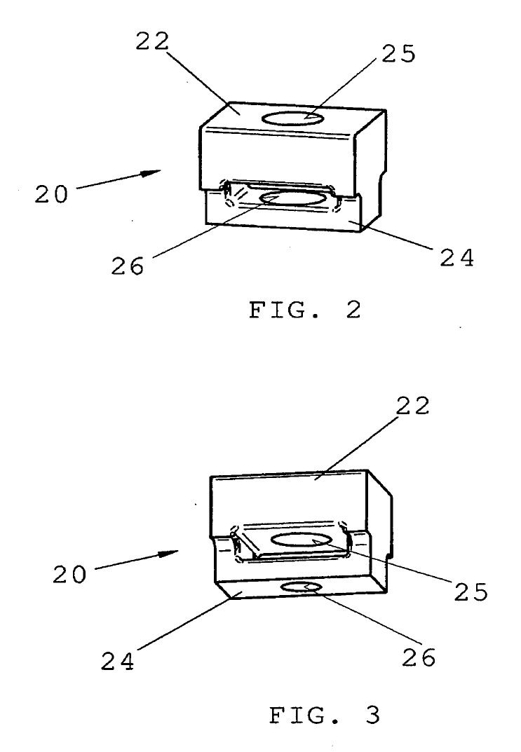

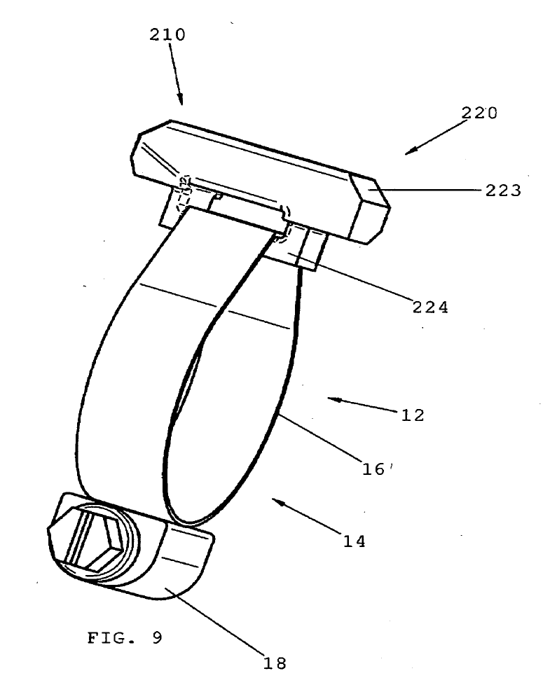

As shown in FIGS. 8A, 8B, 8C, the connector 22 may also be attached directly to a structure or flooring. Referring to FIGS. 2, 3, 5, and 6 connector 20 has a loop 24 with a mounting hole 26. Although a mounting hole is shown in each connector in the drawings, it is also contemplated that the connector not include a mounting hole. The mounting hole 26 is opposite the recess of the receiver 22. The diameter of the mounting hole 26 is smaller than the head of a screw, nail, bolt, anchor, or other fastening device. The diameter of the recess of the receiver 22 is larger than the diameter of the mounting hole 26 to allow inserting the fastening device 48 through the recess of the receiver 22. It is also contemplated that the connector 20 is secured to the structure or flooring using adhesive.

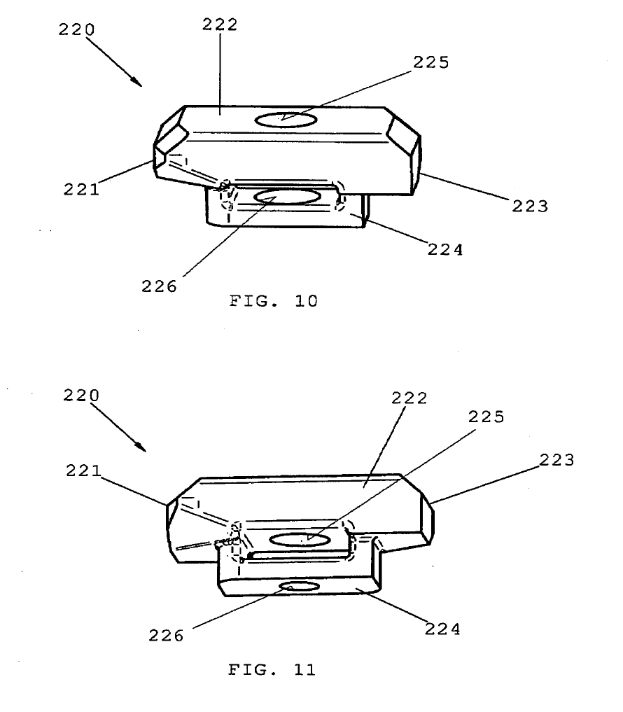

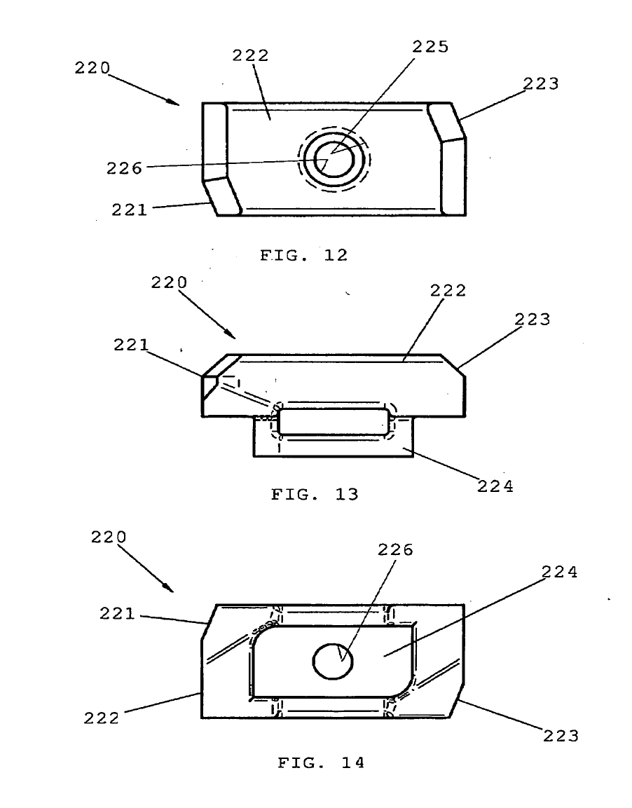

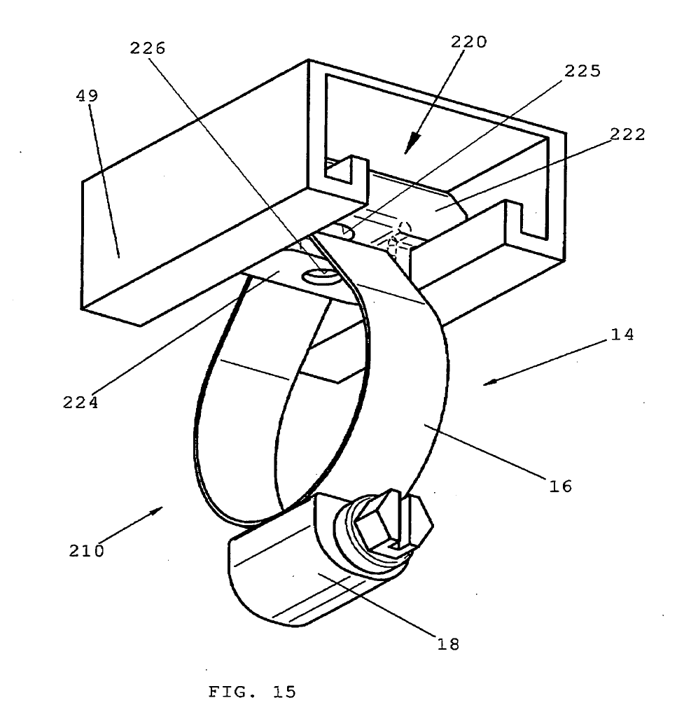

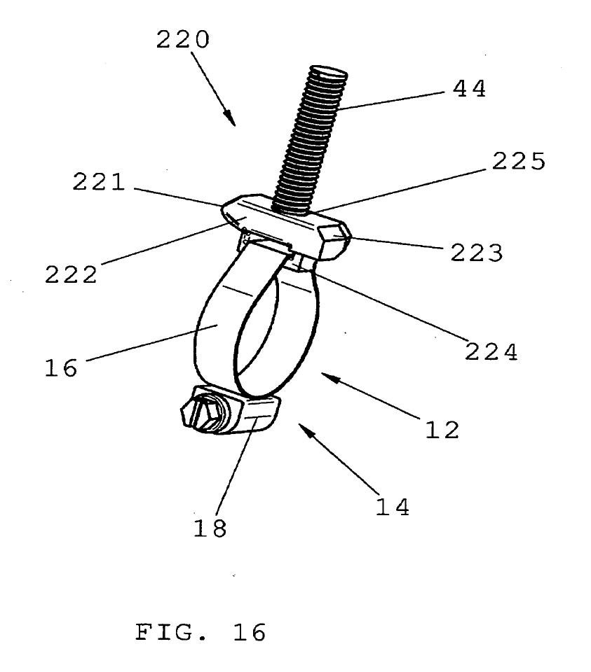

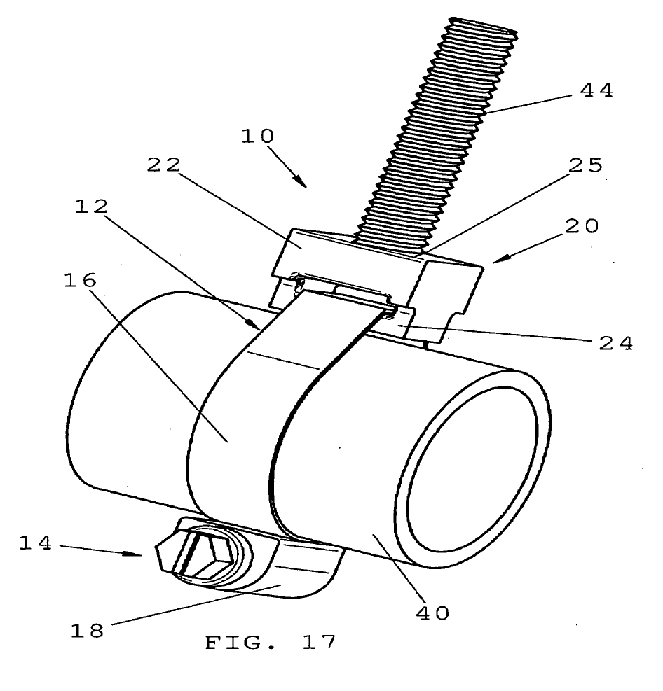

FIG. 9 shows another embodiment of a support that can be used in strut. The band 12 is used with an embodiment of a connector 220 shown in FIGS. 9, 10, 11, 12, 13, and 14. The connector 220 has a receiver 222 which is generally rectangular with opposing corners 221, 223 slanted or slightly rounded for facilitating insertion and removal into strut 49 (see FIG. 15). In one embodiment, receiver 222 has a recess 225 for receiving a mounting rod. In another embodiment the recess 225 has a diameter and pitch for receiving a threaded rod 44 (see FIG. 16) to which support 210 is attached. It is also contemplated that the recess of the receiver 222 does not include threads. It is further contemplated that the recess 225 not be included. A loop 224 extends from receiver 222 to form a gap for receiving band 12. It is also contemplated that the that the loop 224 have a mounting hole 226 for attaching connector 220 to a structure using a fastener.

The supports described above were tested and meet or exceed the MSS SP-58, Pipe Hanger and Supports—Materials, Design, and Manufacture, specifications. The 1993 Edition specifications are included at the end of the specification. It is understood that these specific requirements could be changed. If these specifications are changed, it is within the spirit and scope of these supports to meet the new specification.

The foregoing merely illustrates the principles of the invention. For example, in addition to the parts being made from stainless steel, the parts could also be made of other materials including but not limited to galvanized steel, copper, carbon fiber, plastic or titanium. It is also contemplated that the connectors be made from powdered metal or forging materials, or cast materials.

Although the support band has been illustrated as a worm gear clamp, it is also contemplated that other devices be used. For example, a zip tie could be used. Additionally, it is also contemplated that the support band and connector be combined into a single component.

It will thus be appreciated that those skilled in the art will be able to devise numerous alternative arrangements that, while not shown or described herein, embody the principles of the invention and thus are within its spirit and scope.

We claim:

1. A support that adjusts to support utilities of varying sizes.

2. The support of claim 1 wherein the support meets the MSS SP-58 specification.

3. The support of claim 1 wherein the support supports the utility during adjustment.

4. The support of claim 1 further comprising a band that adjusts to support the utility.

5. The support of claim 4 further comprising a worm gear for adjusting the band.

6. The support of claim 4 wherein the band is a zip strap.

7. A support comprising a connector attached to a band, wherein the band is adjustable while supporting a utility.

8. The support of claim 7 wherein the connector is movably attached to the band.

9. The support of claim 8 wherein the connector further comprises a strap.

10. The support of claim 9 wherein the connector further comprises a receiver.

11. The support of claim 10 wherein the strap of the connector further comprises a hole.

12. The support of claim 11 wherein the hole of the connector strap aligns with the receiver.

13. The support of claim 10 wherein the receiver is threaded.

14. The support of claim 8 wherein the connector is configured to be removably attached to strut.

15. The support of claim 7 further comprising two or more connectors attached to the band.

16. The support of claim 7 wherein the support meets the SP-58 specification.
